(19) United States
(12) Patent Application Publication
(10) Pub. No.: US 2003/0122042 A1
(43) Pub. Date: Jul. 3, 2003

(54) Mobile camper support system

(76) Inventor: Bill B. Williams JR., Liberty Lake, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/038,031

(22) Filed: Jan. 2, 2002

(51) Int. Cl. F16M 11/20

(52) U.S. Cl. 248/188.1

(57) ABSTRACT

A mobile camper support system including a support framework for supporting a camper, plurality of support wheels rotatably mounted on the framework, wherein the wheels are mounted force biased such that when the camper is unloaded from the support framework, the spring bias holds the framework off or above the ground, whereas when the framework is loaded to a predetermined force or weight, such as with a camper, the force bias is overcome and the support framework is forced to the ground and support the framework and camper.

### CROSS REFERENCE TO RELATED APPLICATION

There are no related applications.

### TECHNICAL FIELD

This invention pertains to a mobile camper support system, including an apparatus and method.

### BACKGROUND OF THE INVENTION

For many years, campers have been utilized in combination with pickup trucks for traveling and camping. The typical camper my be secured within the bed of a pickup truck, with an overhead portion which may extend over the cab of the pickup truck and a rearward portion which may extend beyond the rear bumper of the pickup truck. Campers are desirable because they may be removed from the pickup truck and the pickup truck may then be used for other purposes.

Most modern campers include four legs or camper stands integral with the body of the camper. When the camper is mounted on the pickup, the legs or stands may be lowered to the ground to support the camper and to raise the camper so that the truck may be driven out from underneath the raised camper.

The legs on most campers are not as stable as most users prefer and are not considered by many to be a long-term storage option as it is not as stable as many prefer. Many camper owners therefore utilize blocks to support the camper when it is not on the truck. The blocks and/or other structures, which are typically heavy, must be placed underneath the camper and then the camper must be lowered to rest on the structures.

It is difficult and sometimes dangerous to crawl underneath the camper while it is only supported by the legs or stands, and properly move all of the blocks into the desired position. This normally requires the owner to lift the structures while in a bent and prone position, creating a higher risk of injury to move the blocks under the camper.

It is therefore an object of this invention to provide a mobile camper support system which may easily be moved underneath the camper to provide solid support for the camper, and then again be easily removed.

### BRIEF DESCRIPTION OF THE DRAWINGS

Preferred embodiments of the invention are described below with reference to the following accompanying drawings:

FIG. 1 is a side elevation view of a pickup truck, a camper, and one embodiment of a mobile camper support system contemplated by this invention;

FIG. 2 is a side elevation view of a camper supported on an embodiment of a mobile camper support system contemplated by this invention;

FIG. 3 is a perspective view of one embodiment of a mobile camper support system contemplated by this invention;

FIG. 4 is an elevation view of one embodiment of a support leg, wheel and wheel support contemplated by this invention;

FIG. 5 is an elevation view of a support leg, a wheel and wheel support contemplated by this invention, including a lock to allow the wheel to be locked in the downward position;

FIG. 6 is a perspective view of the support leg, wheel and wheel support system illustrated in FIG. 5;

FIG. 7 is an elevation view of one embodiment of a support leg, wheel and wheel support with an enlarged wheel which may be utilized in rougher terrain;

FIG. 8 is an end view of the wheel and wheel support illustrated in FIG. 7, and further illustrating a cotter key lock device which may be utilized to lock the support wheel in the support position;

FIG. 9 is a perspective view of another embodiment of a mobile camper support system in which a storage compartment is provided within the support framework;

FIG. 10 is a perspective view of another embodiment of a mobile camper support system contemplated by this invention, wherein the support wheels are mounted in the support legs; and

FIG. 11 is a perspective view of another embodiment of a mobile camper support system contemplated by this invention, wherein the support wheels are mounted differently and the support framework has a ground interface surface for supporting the support framework.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

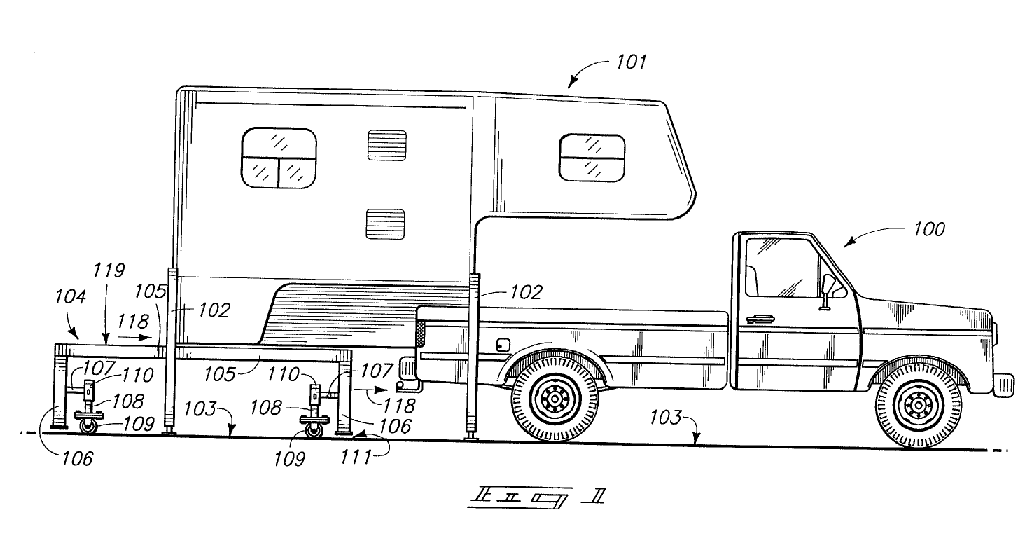

FIG. 1 is a side elevation view of a pickup truck 100, a camper 101 with camper legs 102 or stands, and an embodiment of a mobile camper support system 104 contemplated by this invention. FIG. 1 illustrates that camper 101 has been elevated via camper legs 102 to a position above the bed of pickup truck 100 to allow pickup truck 100 to be removed from underneath the camper to a non-supporting position. At that point, camper legs 102 are the only supporting means for camper 101.

An embodiment of a mobile camper support system 104 may then be easily rolled or pushed in the direction of arrow 118 to a position underneath camper 101 to provide support on support framework support surface 119. By use of the term surface, this should not imply any particular minimum or maximum surface area of the points of contact of the support framework with the camper, as any area or contacts may be utilized within the contemplation of this invention, including points, flat surfaces, end rails, and the like, so long as the surface utilized is sufficient to support the weight of the camper.

FIG. 1 illustrates various components of the embodiment of the mobile camper support system, including support framework 105, support legs 106, support wheels 109, wheel supports 108, framework attachment 107, and wheel support housing 110. It should be noted that camper 101 is supported on ground 103 by camper legs 102. In the mobile camper support system 104, wheels 109 are on the ground and support legs 106 are elevated above the ground and held above the ground by a spring bias within wheel support housing 110 pushing downward on wheel support 108 to hold part or all of the weight of support framework 105 in an elevated position. The support wheel assemblies shown are movably mounted relative to the support framework so the weight of the camper may overcome the combined bias force which the support wheels or support wheel assemblies are placed under. When the camper is placed on the camper support surface, the weight overcomes the combined bias forces the support wheels or support wheel assemblies are mounted under, and the weight of the camper and the camper support are supported by the framework interacting with the ground. The ground may be any one of a number of surfaces, including without limitation, earth, gravel, asphalt, concrete or any other surface or ground upon which the camper support system may be placed.

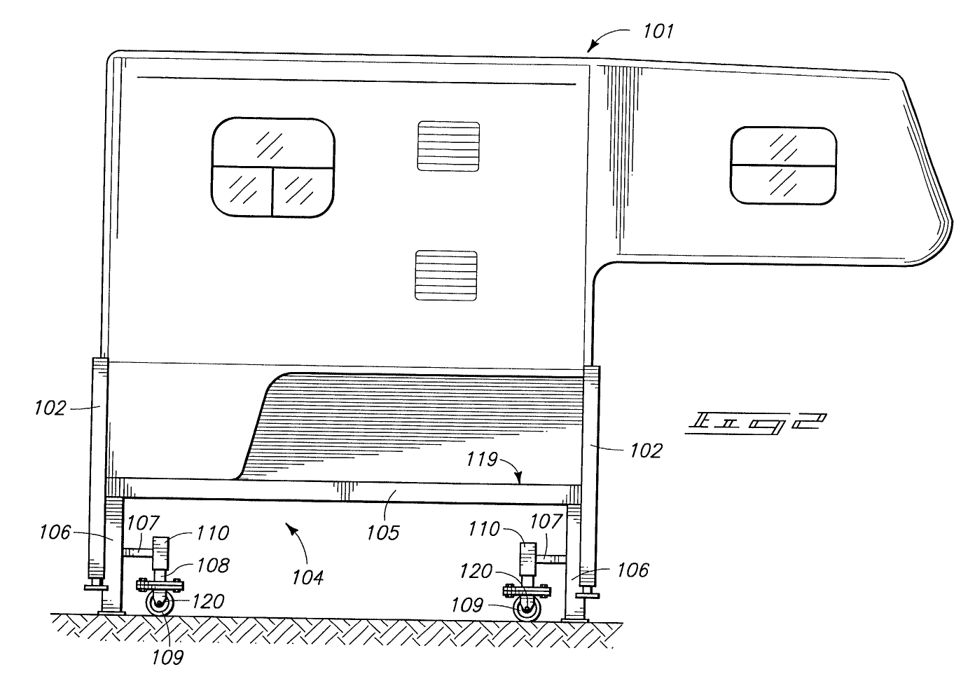

FIG. 2 is a side elevation view of camper 101 being supported by an embodiment of a mobile camper support system 104 contemplated by this invention. FIG. 2 illustrates camper 101 with camper legs 102, support framework 105 with support surface 119, support legs 106 which are bearing the weight of camper 101. Wheels 109 are shown partially retracted as the weight of the camper 101 on the support framework 105 exceeded the downward bias force imposed on wheel support 108 within wheel support housing 110.

Framework connection 107 retains wheel support housing 110 in place. It will be noted that once the camper 101 is sufficiently raised, the bias force on wheel support 108 will push the support framework 105 upward toward the camper until support legs 106 are elevated above the ground. This enables the mobile camper support system to then be removed from underneath the camper to allow the pickup truck to be placed under the camper to install the camper 101 back on the pickup truck. The bias force is preferably (but not limited to) a spring within wheel support housing 110 pushing downward on wheel support 108, of sufficient force to raise the weight of the support framework 105 upwardly.

FIG. 3 is a perspective view of an embodiment of a mobile camper support system 104 contemplated by this invention, illustrating four support legs 106, support framework 105 with support surface 119. As shown in prior figures, framework attachment 107, wheel support housing 110, wheel support 108 and wheel 109 are also shown. In this view, both the wheel and the support legs 106 are on the ground simulating that a camper is placed on the framework, even though a camper is not shown in this figure.

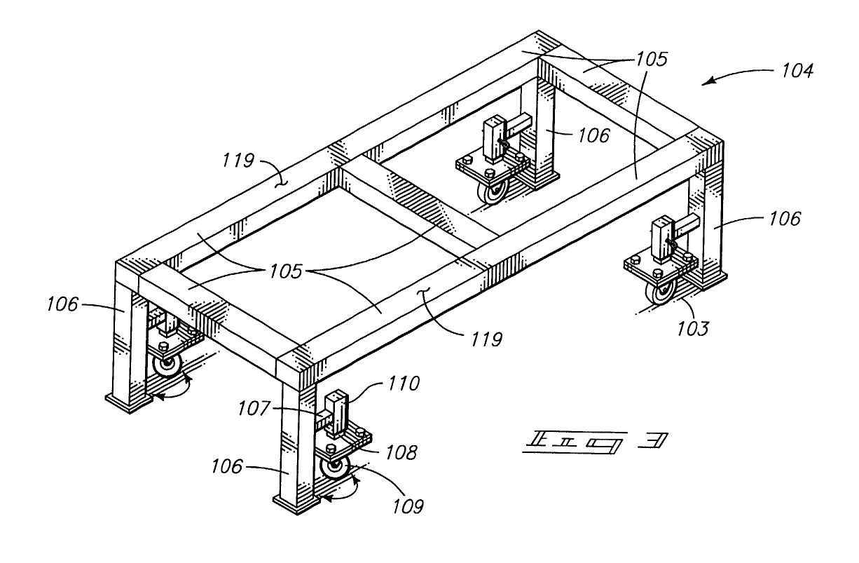

FIG. 4 is an elevation view of a portion of an embodiment of the mobile camper support system, illustrating support framework 105, support leg 106, framework attachment 107, wheel support 108, wheel support housing 110, wheel 109 and wheel axis 120. It should be noted that wheel 109 may be rotatably mounted about a vertical axis by allowing wheel support 108 to rotate within wheel support housing 110. This is preferable in order to allow the mobile camper support system to be rolled in multiple directions more easily as the wheels 109 work more efficiently when pointed in the direction of movement of the overall mobile camper support system.

This type of rotatable wheel is sometimes referred to as a crazy wheel when the vertical axis of rotation does not go directly through the axis of rotation of the wheel. It is preferable to have at least two rotatable wheels (which may be crazy wheels), and all four wheels rotatable. Although utilizing a framework attachment 107 and a wheel support 108 are preferred, neither are necessary to practice the invention as any one of a number of different configurations may be utilized to dispose the wheel with the bias force relative to the support framework 105.

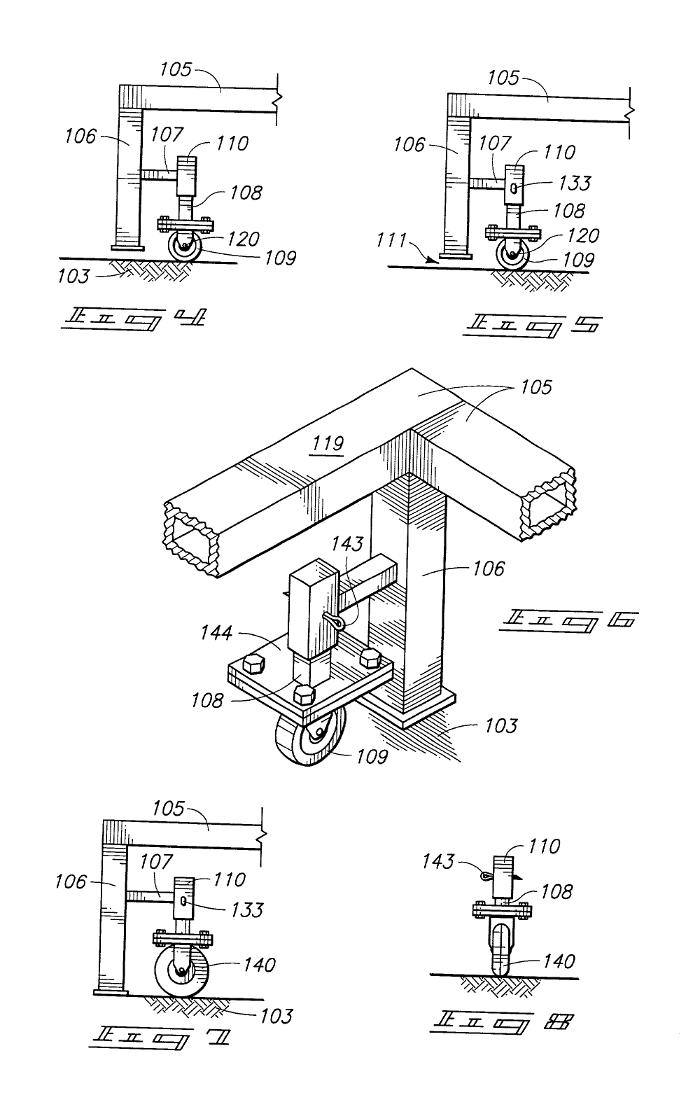

FIG. 5 is another elevation view of a mobile camper support system contemplated by this invention, in an unloaded position such that the bias force is sufficient to hold support legs 106 above the ground level. FIG. 5 illustrates support framework 105, support legs 106, framework attachment 107, wheel support 108, wheel support housing 110, wheel 109 and wheel axis 120. The wheel is on the ground surface supporting the weight of the mobile camper support system.

It should be noted that the bias force is preferably a spring bias force, but it need not be. Instead the bias force may be a manual or powered hydraulic or pneumatic system which includes the bias force. Hydraulic and pneumatic systems are well known and any one of a number of systems may be utilized in this invention. The hydraulic or pneumatic force may be predetermined to be overcome by the predetermined weight of the camper or by the manual release of the force by an owner or operator.

Also shown in FIG. 5 is cotter pin aperture 133 which is a wheel support lock which allows the operator to fix the wheel in a position lower than support leg 106 so that the weight of the camper may be placed on the mobile camper support system and then it may still be rolled or moved with the camper thereon.

FIG. 6 is a perspective view of a corner of a support framework 105, illustrating support surface 119, support leg 106, ground 103, wheel 109, wheel support 108, cotter key 143 and plate 144 which is combined, integrally or part of, wheel support 108.

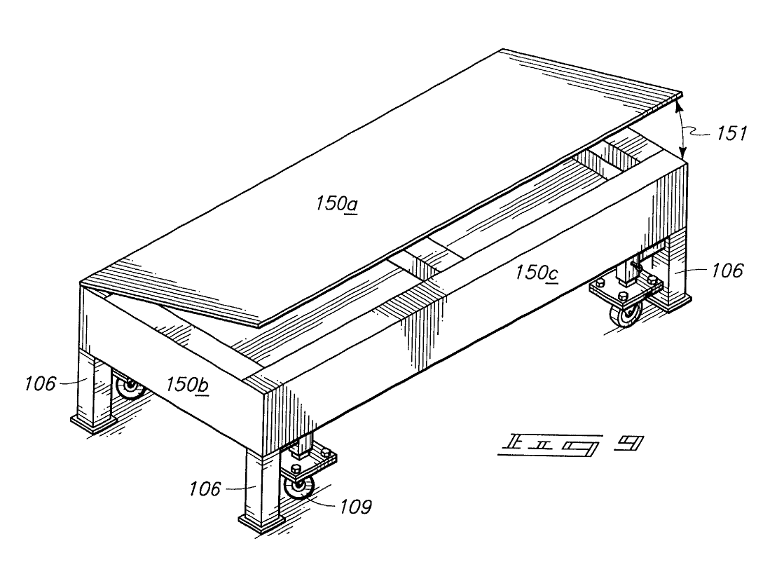

FIG. 7 is an elevation view of an embodiment of a mobile camper support system contemplated by this invention, showing a substantially larger wheel 140. A larger wheel would be much more effective on rough, uneven or outdoor terrain. FIG. 7 also shows ground 103, support leg 106, support framework 105, framework attachment 107, wheel support housing 110 and support lock aperture 133.

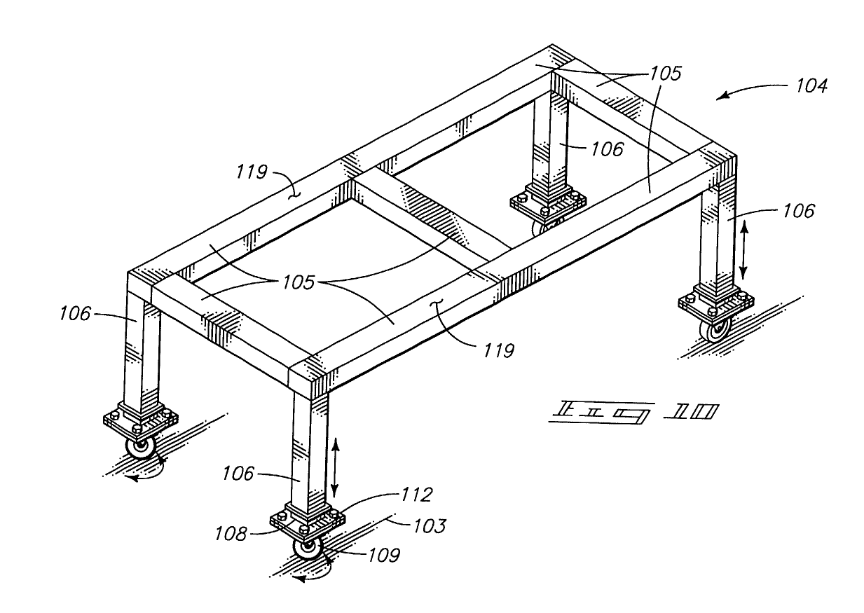

FIG. 8 is another elevation view of the embodiment shown in FIG. 7, illustrating larger wheel 140, wheel support 108, wheel support housing 110 with cotter key 143 inserted in the housing to prevent further movement of wheel support 108 relative to wheel support housing 110. Cotter key 143 is one of many known ways to releasably lock the wheel in a vertical position relative to the support framework and the invention is not limited to any one mechanism or means.

FIG. 9 is a perspective view of another embodiment of a system contemplated by this invention, illustrating one in which a structure is built around or within support framework. The storage area is defined within the area bounded by storage top 150a, storage side 150b and storage side 150c. Storage top 150a rotates upward as indicated by arrow 151. The storage cabinet 150 is built around the framework shown in other prior photographs. The storage cabinet 150 may be configured in any one of a number of ways within the contemplation of this invention, including with drawers or side panels for access while the camper is supported by the mobile support framework.

FIG. 9 also illustrates support legs 106 and wheel 109, which is rotatable about a vertical axis and the vertical axis does not intersect the axis of rotation of the wheel (sometimes referred to as a crazy wheel).

Although the support framework illustrated herein is shown with the preferred four support legs, this invention contemplates that the support framework can be built with at least three or more support legs. It should also be noted that the legs need only have a point or area of support and no particular configuration or shape is required of the support legs to practice this invention. Therefore rails, squares, points and all other configurations, including wheels fixed to the support framework may be utilized. Furthermore the term wheel may include rollers, spheres and other shapes and configurations that allow the relatively easy movement of the support framework relative to the ground.

Furthermore, the term “framework” as used herein is used generically to include any one of a number of different types of structures and configurations of structures to provide a rigid or semi-rigid support to retain a camper above the ground and is to be broadly construed. For instance the framework may be unitary, welded together, assembled in kits with hitch type pins, cotter keys, or in any number of pieces, depending on the application and other desired characteristics (including size and packaging parameters).

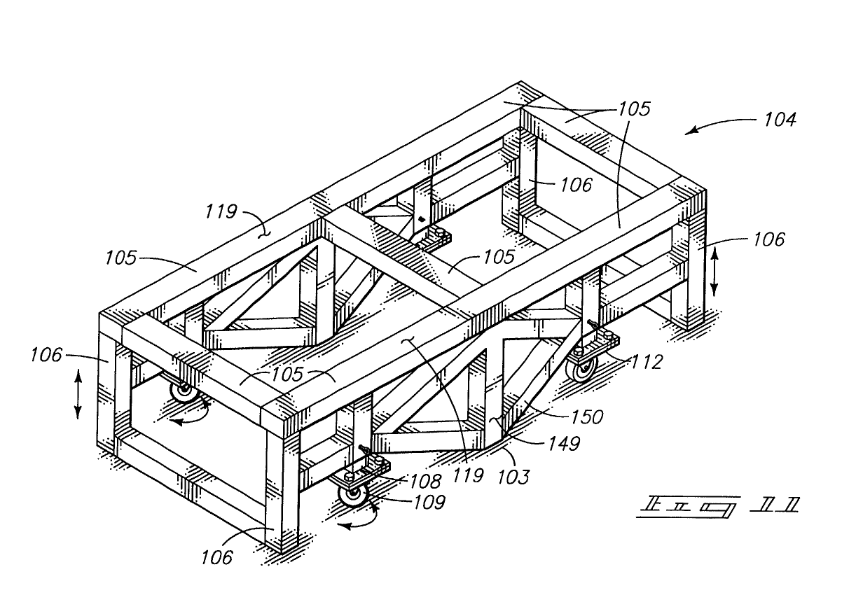

FIG. 10 is a perspective view of another embodiment of a mobile camper support system contemplated by this invention, wherein the support wheels are mounted in the support legs. FIG. 10 illustrates four support legs 106, support framework 105 with support surface 119. In this embodiment, the support wheels 109 are shown mounted within support legs 106. Also in this view, both the support wheels 109 and the support legs 106 are on the ground simulating that a camper is placed on the framework, even though a camper is not shown in this figure.

FIG. 11 is a perspective view of another embodiment of a mobile camper support system contemplated by this invention, wherein the support wheels are mounted differently and the support framework has a support framework 149 section which has a ground interface surface 150 for abutting the ground surface or supporting the support framework on the ground. All other items in FIG. 11 are numbered or identified the same as in earlier figures, such as FIG. 3 and FIG. 10, and will not therefore be repeated here. The ground interaction surface is the surface which interacts or interfaces with the ground, on the lower side of the support framework.

As will be appreciated by those of reasonable skill in the art, there are numerous embodiments to this invention, and variations of elements and components which may be used, all within the scope of this invention.

One embodiment of this invention, for example, is a mobile camper support comprising: a support framework with a camper support surface and at least three support legs; a plurality of support wheels each rotatably mounted to the support framework such that the plurality of support wheels rotate about a wheel axis; the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the camper support surface of the support framework such that the predetermined weight of the camper is supported by the at least three support legs on a ground surface.

Additional embodiments of the mobile camper support described in the preceding paragraph are contemplated and which further wherein: the plurality of support wheels each rotate about a second axis; the second axis is approximately vertical; the plurality of support wheels is two in number; the plurality of support wheels are mounted to the at least three legs of the support framework; a storage container is mounted within the camper support framework; there are four support legs; it comprises a camper support platform on the support framework, the camper support platform being disposed to receive at least part of the camper; it comprises a wheel support lock configured to fix the wheel support in one or more positions such that the weight of the camper is entirely on the plurality of support wheels; the bias force is a spring bias force; the bias force is a pneumatic bias force; the plurality of support wheels are mounted within the plurality of support legs; and/or the plurality of support wheels are round rollers which rotate about an axis.

In another embodiment, a mobile camper support is provided which comprises: a camper support means with a camper support surface and at least three support legs; a plurality of support wheels each rotatably mounted to the camper support means such that the plurality of support wheels rotate about a wheel axis; the plurality of support wheels being mounted to the camper support means under a bias force relative to the camper support means such that bias force between the plurality of support wheels and the camper support means is sufficient to support the camper support means when it is not loaded, and the bias force is exceeded by a predetermined weight of a camper placed on the camper support surface of the camper support means; and such that the predetermined weight of the camper is supported by the at least three support legs on a ground surface.

Additional embodiments of the mobile camper support described in the preceding paragraph are contemplated and which further wherein: the plurality of support wheels each rotate about a second axis; the second axis is approximately vertical; the plurality of support wheels are mounted to the at least three legs of the camper support means; the bias force is a spring bias force; the bias force is a pneumatic bias force; the plurality of support wheels are mounted within the plurality of support legs; and/or the plurality of support wheels are roller means which rotate about an axis.

In yet another embodiment, a mobile camper support is provided which comprises: a support framework with a camper support surface and a ground interaction surface; a plurality of support wheels each rotatably mounted to the support framework such that the plurality of support wheels rotate about a wheel axis; the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the camper support surface of the support framework such that the predetermined weight of the camper is supported by the ground interaction surface of the support framework on a ground surface.

In a further embodiment of the embodiment described in the preceding paragraph, a further embodiment of a mobile camper support is provided further wherein: the plurality of support wheels each rotate about a second axis; the second axis is approximately vertical; the plurality of support wheels is two in number; it further comprises a wheel support lock configured to fix the wheel support in one or more positions such that the weight of the camper is entirely on the plurality of support wheels; the bias force is a spring bias force; the bias force is a pneumatic bias force; the plurality of support wheels are roller means which rotate about an axis.

In a method embodiment of a system contemplated by this invention, a method for supporting a camper with a camper weight is provided, comprising the following: providing a mobile camper support comprising: a support framework with a camper support surface and at least three support legs; a plurality of support wheels each rotatably mounted to the support framework such that the plurality of support wheels rotate about a wheel axis; the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the camper support surface of the support framework such that the predetermined weight of the camper is supported by the at least three support legs on a ground surface; rolling the support framework under the camper; and lowering the camper on to the camper support surface of the support framework, such that the camper weight exceeds the spring bias to force the at least three support legs to contact the ground surface and thereby support the camper.

In a further method embodiment to the method set forth in the preceding paragraph, a method for supporting a camper with a camper weight is provided, and which further comprises raising the camper vertically off the support framework, thereby allowing the spring bias to lift the support framework off the ground surface; and rolling the support framework on the plurality of support wheels away from the camper.

In another method embodiment, a method for supporting a camper with a camper weight is provided, which comprises the following: providing a mobile camper support comprising: a support framework; a plurality of support wheels each rotatably mounted to the support framework such that the plurality of support wheels rotate about a wheel axis; the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the support framework such that the predetermined weight of the camper is supported by the support framework on a ground surface; rolling the support framework under the camper; and lowering the camper on to the support framework, such that the camper weight exceeds the spring bias to force the support framework to contact the ground surface and thereby support the camper.

In a further embodiment of the embodiment described in the preceding paragraph, a further method for supporting a camper with a camper weight is provided and which further comprises raising the camper vertically off the support framework, thereby allowing the spring bias to lift the support framework off the ground surface, and rolling the support framework on the plurality of support wheels away from the camper.

In a further embodiment of the invention, provided is a method for supporting a camper, comprising: providing a mobile camper support comprising: a support framework; a plurality of support wheels each rotatably mounted to the support framework such that the plurality of support wheels rotate about a wheel axis; rolling the support framework under the camper; and lowering the camper on to the support framework, such that the camper weight is supported by the support framework on wheels. A yet further embodiment is providing the forenamed support wheels with a support wheel lock mechanism to selectively prevent the rotation of the support wheels. Wheel lock mechanisms to selectively prevent the rotation of wheels are known and will not therefore be discussed in significant detail here.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A mobile camper support, comprising:
a support framework with a camper support surface and at least three support legs;
a plurality of support wheels each rotatably mounted to the support framework such that
the plurality of support wheels rotate about a wheel axis;
the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the camper support surface of the support framework such that the predetermined weight of the camper is supported by the at least three support legs on a ground surface.

2. A mobile camper support as recited in claim 1, and further wherein the plurality of support wheels each rotate about a second axis.

3. A mobile camper support as recited in claim 2, and further wherein the second axis is approximately vertical.

4. A mobile camper support as recited in claim 2, and further wherein the plurality of support wheels is two in number.

5. A mobile camper support as recited in claim 1, and further wherein the plurality of support wheels are mounted to the at least three legs of the support framework.

6. A mobile camper support as recited in claim 1, and further wherein a storage container is mounted within the camper support framework.

7. A mobile camper support as recited in claim 1, and further wherein there are four support legs.

8. A mobile camper support as recited in claim 1, and further comprising a camper support platform on the support framework, the camper support platform being disposed to receive at least part of the camper.

9. A mobile camper support as recited in claim 1, and further comprising a wheel support lock configured to fix the wheel support in one or more positions such that the weight of the camper is entirely on the plurality of support wheels.

10. A mobile camper support as recited in claim 1, and further wherein the bias force is a spring bias force.

11. A mobile camper support as recited in claim 1, and further wherein the bias force is a pneumatic bias force.

12. A mobile camper support as recited in claim 1, and further wherein the plurality of support wheels are mounted within the plurality of support legs.

13. A mobile camper support as recited in claim 1, and further wherein the plurality of support wheels are round rollers which rotate about an axis.

14. A mobile camper support, comprising:
a camper support means with a camper support means and a ground interaction means;
a plurality of support wheels each rotatably mounted to the camper support means such that the plurality of support wheels rotate about a wheel axis;
the plurality of support wheels being mounted to the camper support means under a bias force relative to the camper support means such that bias force between the plurality of support wheels and the camper support means is sufficient to support the camper support means when it is not loaded, and the bias force is exceeded by a predetermined weight of a camper placed on the camper support surface of the camper support means; and
such that the predetermined weight of the camper forces the ground interaction means to the ground to support the weight of the camper.

15. A mobile camper support as recited in claim 14, and further wherein the plurality of support wheels each rotate about a second axis.

16. A mobile camper support as recited in claim 15, and further wherein the second axis is approximately vertical.

17. A mobile camper support as recited in claim 14, and further wherein the plurality of support wheels are mounted to the at least three legs of the camper support means.

18. A mobile camper support as recited in claim 14, and further wherein the bias force is a spring bias force.

19. A mobile camper support as recited in claim 14, and further wherein the bias force is a pneumatic bias force.

20. A mobile camper support as recited in claim 14, and further wherein the plurality of support wheels are mounted within the plurality of support legs.

21. A mobile camper support as recited in claim 14, and further wherein the plurality of support wheels are roller means which rotate about an axis.

22. A mobile camper support as recited in claim 14, and further wherein the ground interaction means is at least three support legs.

23. A mobile camper support, comprising:
a support framework with a camper support surface disposed to receive a camper and with a ground interaction surface;
a plurality of support wheel assemblies each movably mounted to the support framework, each support wheel assembly including a support wheel which rotates about a wheel axis;
the plurality of support wheel assemblies being mounted to the support framework under a bias force away from the support framework such that:
the combined bias force of the plurality of support wheel assemblies is of sufficient magnitude to support the support framework above the ground when the support framework is not loaded; and
the combined bias force is exceeded by a predetermined weight of a camper which may be placed on the camper support surface, which forces the ground interaction surface to the ground to support the weight of the camper.

24. A mobile camper support as recited in claim 23 and further wherein the ground interaction surface of the support framework is on at least three support legs.

25. A mobile camper support as recited in claim 23, and further wherein the plurality of support wheels each rotate about a second axis.

26. A mobile camper support as recited in claim 25, and further wherein the second axis is approximately vertical.

27. A mobile camper support as recited in claim 23, and further wherein the plurality of support wheels is two in number.

28. A mobile camper support as recited in claim 23, and further comprising a wheel support lock configured to fix the wheel support in one or more positions such that the weight of the camper is entirely on the plurality of support wheels.

29. A mobile camper support as recited in claim 23, and further wherein the bias force is a spring bias force.

30. A mobile camper support as recited in claim 23, and further wherein the bias force is a pneumatic bias force.

31. A mobile camper support as recited in claim 23, and further wherein the plurality of support wheels are roller means which rotate about an axis.

32. A method for supporting a camper with a camper weight, comprising the following:
providing a mobile camper support comprising:
a support framework with a camper support surface and at least three support legs;
a plurality of support wheels each rotatably mounted to the support framework such that the plurality of support wheels rotate about a wheel axis;
the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the camper support surface of the support framework such that the predetermined weight of the camper is supported by the at least three support legs on a ground surface;
rolling the support framework under the camper; and
lowering the camper on to the camper support surface of the support framework, such that the camper weight exceeds the spring bias to force the at least three support legs to contact the ground surface and thereby support the camper.

33. A method for supporting a camper with a camper weight as recited in claim 32, and further comprising the following:
raising the camper vertically off the support framework, thereby allowing the spring bias to lift the support framework off the ground surface; and
rolling the support framework on the plurality of support wheels away from the camper.

34. A method for supporting a camper with a camper weight, comprising the following:
providing a mobile camper support comprising:
a support framework;
a plurality of support wheels each rotatably mounted to the support framework such that the plurality of support wheels rotate about a wheel axis;
the plurality of support wheels being mounted to the support framework under a bias force relative to the support framework such that bias force between the support wheels and the support framework is sufficient to support the support framework when the support framework is not loaded, and the bias force is exceeded by a predetermined weight of a camper placed on the support framework such that the predetermined weight of the camper is supported by the support framework on a ground surface
rolling the support framework under the camper; and
lowering the camper on to the support framework, such that the camper weight exceeds the spring bias to force the support framework to contact the ground surface and thereby support the camper.

35. A method for supporting a camper with a camper weight as recited in claim 34, and further comprising the following:
raising the camper vertically off the support framework, thereby allowing the spring bias to lift the support framework off the ground surface; and
rolling the support framework on the plurality of support wheels away from the camper.

36. A method for supporting a camper, comprising the following:
providing a mobile camper support comprising:
a support framework;
a plurality of support wheels each rotatably mounted to the support framework such that the plurality of support wheels rotate about a wheel axis;
rolling the support framework under the camper; and
lowering the camper on to the support framework, such that the camper weight is supported by the support framework on wheels.

37. A method for supporting a camper with a camper weight as recited in claim 36, and further comprising a support wheel lock mechanism to selectively prevent the rotation of the support wheels.
